(19) United States
(12) Patent Application Publication
(10) Pub. No.: US 2009/0000746 A1
(43) Pub. Date: Jan. 1, 2009

(54) Apparatus for producing jumbo rolls

(75) Inventors: Heinz-Jurgen Dern, Menden (DE); Claudio Lesizza, Milan (IT); Guglielmo Tonin, Milanese (IT)

Correspondence Address: Charles A. Muserlian,;c/o Hedman and Costigan, 1185 Avenue of the Americas, New York, NY, 10036, US

(73) Assignees: BAKELITE AG; IMT. S.r.l.

(21) Appl. No.: 11/973,787

(22) Filed: Oct. 10, 2007

Related U.S. Application Data
(62) Division of application No. 10/509,407, filed on Oct. 21, 2004, now abandoned.

(30) Foreign Application Priority Data
Mar. 26, 2002 (DE) 202 04 849.7

(51) Int. Cl. B32B 37/00

(52) U.S. Cl. 156/380.9

(57) ABSTRACT

The invention relates to an apparatus for producing jumbo rolls during the production of coated abrasive products.

In order to provide an apparatus with which jumbo rolls can be produced during the production of coated abrasive products in such a way that uniform, rapid heating of the jumbo roll in the oven is made possible, it is proposed that a heating apparatus be connected directly before or to the winder for the pre-cured abrasive belt, with which apparatus the belt is heated to a uniform temperature over its entire width.

The invention relates to an apparatus for producing jumbo rolls during the production of coated abrasive products.

During this production, in a plurality of process steps connected one after another, an endless belt of carrier material is continuously provided with a basic binder, with abrasive material and with at least one top binder. In each case following the application of the binder layers, drying or pre-curing of the thermosetting binder is carried out. At the end of the production process, the coated, dried and pre-cured, adhesive-free abrasive belt is wound up on a winder to form what is known as a jumbo roll (cf. Gardziella, Pilato, Knop; Phenolic Resins, second edition (2000), Springer Verlag, p. 345).

In order to cure the thermosetting binder, the jumbo roll is introduced into an oven and heated there to a temperature above the curing temperature of the thermosetting binder, as a rule, when phenolic resins are used as binder, to a temperature >130° C.

Although, in the course of its production, in particular during the pre-curing of the binder in what is known as the top binding oven, the abrasive belt is already heated to an elevated temperature, this thermal energy is largely lost on the way from the top binding oven to the winder as a result of braking and guide rolls and the path through the cold air in the hall. It must be resupplied in the curing oven for the jumbo roll.

Depending on the size of the jumbo roll and, in particular, when there are large differences between the temperature of the abrasive belt when it emerges from the top binding oven and at the winder, intense temperature differences result in the jumbo roll in the oven. For example, the edges and the outer layers are immediately hot, while the core of the jumbo roll heats up only very slowly. As a result, not only does inhomogeneous curing of the thermosetting binder occur, but, in the case of blue top binders, there is additionally very intensely different discoloration of the surface. As a result of the temperature stress, the very quickly heated and overheated parts of the abrasive belt slowly discolour via green to brown, while the inner, cooler core of the jumbo roll remains beautifully blue. In order at least to reduce this problem, the jumbo rolls are heated up extremely slowly, which leads firstly to high energy costs and secondly to poor productivity.

It is therefore an object of the present invention to provide an apparatus with which jumbo rolls can be produced during the production of abrasive coated products in such a way that uniform, rapid heating of the jumbo roll in the oven is made possible, and therefore the problems of non-uniform curing of the abrasive are avoided.

The object is achieved by an apparatus according to Claims 1 to 6.

The apparatus consists in a heating apparatus being connected directly before or to the winder for the pre-cured abrasive belt, with which apparatus the abrasive belt is heated to a uniform temperature over its entire width. This temperature expediently lies at or slightly below the desired curing temperature of the thermosetting binder.

Achieving the object according to the invention in this way by means of an additional heating apparatus, which is connected directly before or to the winder, has the further advantage that re-equipping an already existing installation is possible without great structural changes having to be made.

The heating apparatus which can be used is all apparatuses which supply the highest and most controllable power density, in order to provide the heating of the abrasive belt in the shortest possible time and over the shortest possible path length. Heating apparatuses of this type are, for example, radiant heaters, in particular thermal or infrared radiant heaters, which are aimed in such a way that the abrasive belt is irradiated uniformly over its entire width in a specific section either shortly before reaching the winder or in each case on the outer path on the winder.

According to the invention, however, it is also possible to use as heating apparatuses an oven, in particular a recirculating oven or a short-wave or microwave heating apparatus, through which the abrasive belt passes. Furthermore, heated rolls or heated conveyor belts, connected upstream of the winder and over which the abrasive belt is guided, can also be used as heating apparatuses corresponding to the invention.

The abrasive belt brought to the desired temperature over its entire width in the heating apparatus according to the invention is wound up immediately thereafter on the winder to form the jumbo roll. The jumbo roll obtained in this way has a uniform temperature, which preferably lies at or slightly below the curing temperature of the thermosetting binder. It is immediately introduced into the oven and heated to a temperature above the curing temperature of the thermosetting binder. As a result of the preheating of the abrasive belt which has been carried out, only a relatively small supply of energy is still necessary for the further heating of the jumbo roll. As a result, the heating is carried out quickly and permits production to be increased. Nevertheless, only small temperature differences occur in the jumbo roll, the curing of the thermosetting binder takes place uniformly and no undesirable discoloration effects occur.

1-6. (canceled)

7. A process for producing coated abrasive products in the form of jumbo rolls including at least the steps of:
a) applying a basic binder to a base material,
b) applying abrasive material to the basic binder,
c) applying a thermosetting top binder to the dried or pre-cured composite from step b) to fabricate the abrasive belt,
d) heating the abrasive belt in its entire width to a uniform temperature immediately before or directly at a winder for producing a jumbo roll,
e) producing the jumbo roll by winding up the heated and pre-cured abrasive belt at the winder and immediately thereafter and
f) fully curing the jumbo roll.

8. The process of claim 7 wherein the heating apparatus is a thermal radiant heater which irradiates the abrasive belt uniformly over its entire width before reaching the winder.

9. The process of claim 7 wherein the heating apparatus is a thermal radiant heater which in each case irradiates one section at a time of the outer path of the abrasive belt over its entire width on the winder.

10. The process of claim 7 wherein the heating apparatus is a recirculating oven, through which the abrasive belt is passed.

11. The process of claim 7 wherein the heating apparatus is a short-wave or microwave heating apparatus, through which the abrasive belt is passed.

12. The process of claim 7 wherein the heating apparatus is a heated roll, over which the abrasive belt is guided.

13. The process of claim 7 wherein the heating temperature is set close to or just below the curing temperature of the thermosetting top binder.
